(19) United States
(12) Patent Application Publication
(10) Pub. No.: US 2026/0075074 A1
(43) Pub. Date: Mar. 12, 2026

(54) SUSPICIOUS BEHAVIOR REPORTING

(71) Applicant: Lenovo (Singapore) Pte. Limited, Singapore (SG)

(72) Inventors: Sheeba Backia Mary Baskaran, Friedrichsdorf (DE); Andreas Kunz, Ladenburg (DE)

(73) Assignee: Lenovo (Singapore) Pte. Limited, Singapore (SG)

(21) Appl. No.: 19/109,328

(22) PCT Filed: Sep. 30, 2023
(86) PCT No.: PCT/IB2023/059819

§ 371 Date: Mar. 6, 2025

Related U.S. Application Data
(60) Provisional application No. 63/411,926, filed on Sep. 30, 2022.

(51) Int. Cl. H04L 9/40

(52) U.S. Cl. CPC H04L 63/1425; H04L 63/1416

(57) ABSTRACT

Various aspects of the present disclosure relate to methods, apparatuses, and systems that support suspicious behavior reporting. For instance, implementations provide techniques for aggregating data pertaining to suspicious behavior in wireless communications and for propagating the data to different entities in wireless systems. By utilizing the described techniques, device and information security in wireless communications can be enhanced.

### RELATED APPLICATION

This application claims priority to U.S. Provisional Application Ser. No. 63/411,926 filed 30 Sep. 2022 entitled “SUSPICIOUS BEHAVIOR REPORTING,” the disclosure of which is incorporated by reference herein in its entirety.

### TECHNICAL FIELD

The present disclosure relates to wireless communications, and more specifically to security in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for attempting to identify malicious behavior in wireless communications. However, such systems may be limited in their ability to collect some types of data related to potentially malicious behavior.

### SUMMARY

The present disclosure relates to methods, apparatuses, and systems that support suspicious behavior reporting. For instance, implementations provide techniques for aggregating data pertaining to suspicious behavior in wireless communications and for propagating the data to different entities in wireless systems. By utilizing the described techniques, device and information security in wireless communications can be enhanced.

Some implementations of the methods and apparatuses described herein may further include generating, by a first apparatus, suspicious behavior data based on detected suspicious behavior pertaining to a direct communication of a second apparatus with the first apparatus, the suspicious behavior data including an event identifier, a timestamp, and one or more of an event identifier, the identifier for the second apparatus, an application identifier, a service type, service function information, an identifier for the first apparatus, a destination relay identifier, or traffic telemetry data; generating a suspicious behavior report including at least some of the suspicious behavior data; and transmitting the suspicious behavior report.

Some implementations of the methods and apparatuses described herein may further include: where the suspicious behavior includes one or more of misbehavior pertaining to the direct communication, malicious behavior pertaining to the direct communication, or suspected malicious behavior pertaining to the direct communication; further including collecting the traffic telemetry data from the second apparatus, the traffic telemetry data including one or more of suspicious data or a suspicious message; the first apparatus includes a first user equipment (UE) and the second apparatus includes one or more of a second UE, a UE-network relay, or a relay node; further including detecting the suspicious behavior based on at least one of: the second apparatus causes multiple direct communication link failures; a message exchange pertaining to the direct communication includes one or more of traffic or data which deviates from at least one of a standard message exchange protocol or a standard message exchange format; the second apparatus executes an operation unrecognized by the first apparatus; the second apparatus transmits data which exceeds a threshold; a detected error in a direct communication set up procedure which is implemented with the second apparatus; or a detected error in a direct communication link that is established with the second apparatus; the threshold pertains to one or more of a configured limit or a processing capability.

Some implementations of the methods and apparatuses described herein may further include: where the identifier for the second apparatus includes one or more of a destination ProSe relay UE identifier, a destination Layer-2 identifier, or a ProSe Layer-2 group identifier; the identifier for the first apparatus includes one or more of a source ProSe relay UE identifier, a source Layer-2 identifier, or a ProSe Group identifier; the service type includes at least one of ProSe, U2X, or V2X; further including transmitting in the suspicious behavior report the information about at least one serving function, and wherein the at least one serving function includes one or more of a ProSe service function, a U2X service function, or a V2X service function; further including: determining to transmit the suspicious behavior report using a control plane; and transmitting the suspicious behavior report to an Access and Mobility Management Function (AMF) over Non-Access Stratum (NAS) transport; further including: determining to transmit the suspicious behavior report using a user plane; and transmitting the suspicious behavior report to an Application Function (AF); determining to transmit the suspicious behavior report using a user plane includes determining to transmit the suspicious behavior report using an application-level connection.

Some implementations of the methods and apparatuses described herein may further include receiving, by a first apparatus, a suspicious behavior report including suspicious behavior data based on detected suspicious behavior pertaining to a direct communication between a second apparatus and a third apparatus, the suspicious behavior data including an event identifier, a timestamp, and one or more of an event identifier, a source identifier for the second apparatus, an application identifier, a service type, service function information, an identifier for the first apparatus, a destination relay identifier, or traffic telemetry data; and transmitting the suspicious behavior report to a fourth apparatus.

Some implementations of the methods and apparatuses described herein may further include: where the first apparatus includes an AF, the second apparatus includes a first user equipment (UE) that generates the suspicious behavior report, and the third apparatus includes one or more of a second UE, a UE-network relay, or a relay node that causes behavior described by at least some of the suspicious behavior data; the fourth apparatus includes at least one of a Network Data Analytics Function (NWDAF) or a Network Exposure Function (NEF); further including receiving, from the fourth apparatus, an acknowledgement message based at least in part on the suspicious behavior report.

Some implementations of the methods and apparatuses described herein may further include receiving, at a first apparatus from a second apparatus, a suspicious behavior report including suspicious behavior data based on detected suspicious behavior pertaining to a direct communication between a third apparatus and a fourth apparatus; and transmitting, based at least in part on the suspicious behavior report, an acknowledgement message to the second apparatus.

Some implementations of the methods and apparatuses described herein may further include: where the first apparatus includes a NWDAF, the second apparatus includes at least one of an AF or a NEF, the third apparatus includes a first user equipment (UE) that generates at least some of the suspicious behavior data, and the fourth apparatus includes one or more of a second UE, a UE-network relay, or a relay node that causes behavior described by the at least some of the suspicious behavior data; the suspicious behavior data includes an event identifier, a timestamp, and one or more of an event identifier, a source identifier for the fourth apparatus, an application identifier, a service type, service function information, an identifier for the third apparatus, a destination relay identifier, or traffic telemetry data; the suspicious behavior data includes an event identifier, a timestamp, and one or more of an event identifier, the identifier for the second apparatus, an application identifier, a service type, service function information, an identifier for the first apparatus, a destination relay identifier, or traffic telemetry data; further including outputting analytics data including one or more of a list of observed exceptions, a detected risk, an attack type associated with the suspicious behavior data, an indication of a severity of the suspicious behavior, a list of one or more UE-related devices suspected to be a cause of the suspicious behavior, a list of one or more UE-related devices suspected to be impacted due to other UE's suspicious behavior, or an indication of a confidence value pertaining to the suspicious behavior.

Some implementations of the methods and apparatuses described herein may further include receiving, at a first apparatus from a second apparatus and over Non-Access Stratum (NAS) transport, a suspicious behavior report including suspicious behavior data based on detected suspicious behavior pertaining to a direct communication between the second apparatus and a third apparatus; and transmitting the suspicious behavior report to a fourth apparatus.

Some implementations of the methods and apparatuses described herein may further include: where the first apparatus includes an Access and Mobility Management Function (AMF), the second apparatus includes a first user equipment (UE) that generates at least some of the suspicious behavior data, the third apparatus includes one or more of a second UE, a UE-network relay, or a relay node that causes behavior described by the at least some of the suspicious behavior data, and the fourth apparatus includes a NWDAF; further including: receiving, from the second apparatus and pertaining to the suspicious behavior report, one or more of a freshness parameter, a Subscription Permanent Identifier (SUPI), or a message authentication code (MAC); and transmitting, to the fourth apparatus, one or more of the freshness parameter, the SUPI, or the MAC.

### BRIEF DESCRIPTION OF THE DRAWINGS

FIG. 1 illustrates an example of a wireless communications system that supports suspicious behavior reporting in accordance with aspects of the present disclosure.

FIG. 2 illustrates a procedure for data collection from a UE.

FIG. 3 illustrates a procedure that supports suspicious behavior reporting in accordance with aspects of the present disclosure.

FIG. 4 illustrates a procedure that supports suspicious behavior reporting in accordance with aspects of the present disclosure.

FIG. 5 illustrates a procedure that supports suspicious behavior reporting in accordance with aspects of the present disclosure.

FIG. 6 illustrates a procedure that supports suspicious behavior reporting in accordance with aspects of the present disclosure.

FIGS. 7 and 8 illustrate examples of block diagrams of devices that support suspicious behavior reporting in accordance with aspects of the present disclosure.

FIGS. 9 through 12 illustrate flowcharts of methods that support suspicious behavior reporting in accordance with aspects of the present disclosure.

### DETAILED DESCRIPTION

In wireless communications systems, support may be provided for AF-based UE data collection for UE-related data analytics. Some existing procedures, however, do not specify what information a UE uses to determine to provide an AF with data related to suspicious behaviors, such as to identify cyber-attack(s). Further, some existing data collection procedures for UEs (e.g., using AFs) do not specify which data is to be collected for different scenarios related to direct communications, e.g., direct communication involving relays that exhibit suspicious behavior, direct communications involving relay(s) where a UE exhibit suspicious behavior, V2X scenarios where a UE exhibits suspicious behavior, etc. A lack of sufficient data on such behavior can result in an analytics functionality (e.g., NWDAF) failing to identify security risks (e.g., cyber-attacks) as well as failing to identify identities of entities that cause such security risks and the extent of such security risks.

Accordingly, this disclosure provides for techniques that support suspicious behavior reporting. For instance, implementations provide techniques for aggregating data pertaining to suspicious behavior in wireless communications and for propagating the data to different entities in wireless systems. By utilizing the described techniques, device and information security in wireless communications can be enhanced.

Aspects of the present disclosure are described in the context of a wireless communications system. Aspects of the present disclosure are further illustrated and described with reference to device diagrams and flowcharts.

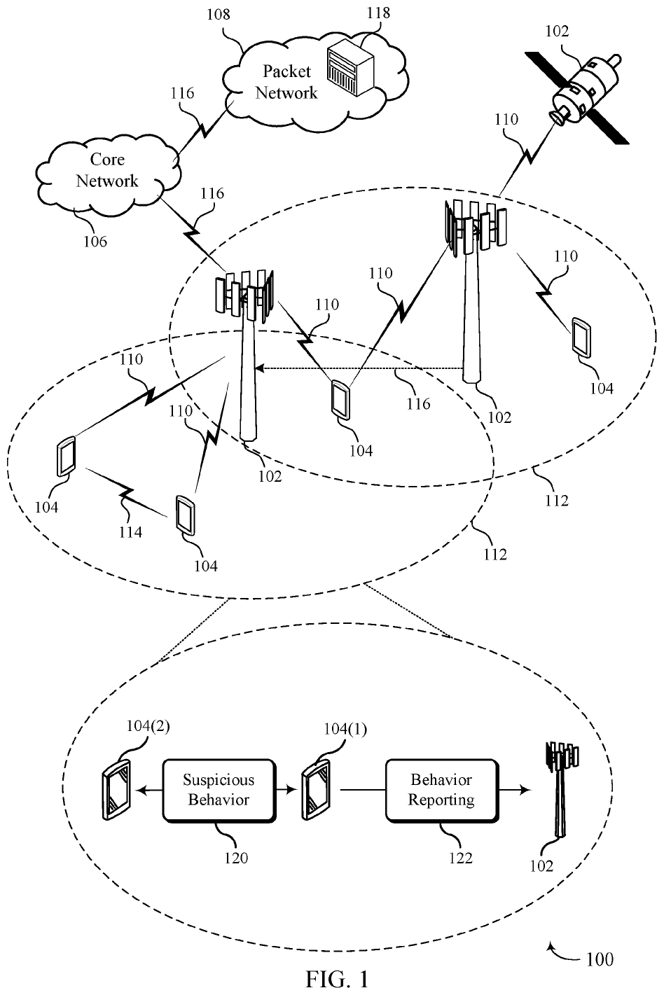

FIG. 1 illustrates an example of a wireless communications system 100 that supports suspicious behavior reporting in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for suspicious behavior reporting, a UE 104(1) can engage in direct wireless communication with a UE-related device 104(2). The direct wireless communication can be implemented in various ways, such as ProSe transmissions, sidelink transmissions, and so forth. In conjunction with the direct wireless communication, the UE 104(1) can detect suspicious behavior 120. The suspicious behavior 120, for instance, represents behavior exhibited by the UE 104(2) as part of the direct wireless communication that exhibits attributes of malicious behavior, e.g., behavior that may cause a security risk. Accordingly, the UE 104(1) aggregates data describing various attributes of the suspicious behavior 120 and communicates behavior reporting 122 to a network entity 102 describing the suspicious behavior 120. In implementations, the network entity 102 can perform an action to mitigate risks caused by the suspicious behavior 120, such as flagging the UE 104(2) as a security risk, preventing the UE 104(2) from connecting to an associated network, etc.

In some wireless communications systems, the notion of an NWDAF detecting cyber-attacks by monitoring events and data packets in the UE and the network has been discussed, such as with the support of machine-learning algorithms. To achieve cyber-attacks detection, the NWDAF can collaborate with UE and any other NFs to collect related data as inputs and providing alerts of anomaly events as outputs to OAM and other NFs which have subscribed to them so that they could take proper actions.

Further, the following key issues related to cyber-attack detection have been described:

### Key Issues on Cyber-Attack Detection

This key issue describes what kind of cyber-attacks can be detected. In order to mitigate the identified cyber-attacks, the data/parameters collected by the NWDAF or any other Network Function (NF) are to be studied.

The specific cyber-attacks for which an analytics function may provide detection support include but are not limited to the following examples:
(1) MitM attacks on the radio interface: MitM attacks or fraudulent relay nodes may modify or change messages between the UE and the RAN, resulting in failures of higher layer protocols such as NAS or the primary authentication.
(2) DoS attacks: 5G has high performance requirements for system capacity and data rate, improved capacity and higher data rate may lead to much higher processing capability cost for network entities, which may make some network entities (e.g. RAN, Core Network Entities) to suffer from DDoS attack. The NFs may also enable the detection of DDoS attacks.

### Security Threats

Cyber-attack may not be detected by the 5G network; thus further attacks could be conducted. Anomaly events may not be detected by the 5G network; thus further attacks could be conducted.

### Potential Security Requirements

The 3GPP system is to support the detection of cyber-attacks by providing related inputs or collecting output analytics using an analytics function (for e.g., NWDAF).

Concerning data collection from a UE application, an NWDAF may interact with an AF to collect data from UE Application(s) as an input for analytics generation and Machine Learning (ML) model training. The AF can be in the Mobile Network Operator (MNO) domain or an AF external to MNO domain. The data collection request from NWDAF may trigger the AF to collect data from the UE Application. The UE Application establishes a connection to the AF in the MNO domain or external to MNO domain over user plane via a PDU session. The AF communicates with the UE Application and collects data from UE Application. For both an AF in trusted domain and an AF in untrusted domain (which supports to collect data from a UE Application), the Service Level Agreement (SLA) between the operator and the Application Service Provider (e.g. ASP) determines per Application identifier (ID) in use by the ASP:
The AF for the UE Application to connect to (e.g. based on a Fully Qualified Domain Name (FQDN)).
The information that the UE Application shares with the AF, subject to user consent.
Possible Data Anonymization, Aggregation or Normalization algorithms (if used).
The authentication information that enable the AF to verify the authenticity of the UE's Application that provides data.

The AF (which supports the data collection) can be configured based on the SLA above. Further, data anonymization, aggregation or normalization algorithms within the SLA are defined per individual UE.

A UE Application (which can support providing data to an AF) can be configured by the ASP with the Application ID to use in the communication with the AF and then the UE Application is configured per Application ID with the following information:
The address of the AF to contact.
The parameters that the UE Application is authorized to provide to the AF.
The authentication information to enable the UE Application to verify the authenticity of the AF that requests data.

The Target for Event Reporting in the Naf_EventExposure request may be set to:
an external UE ID (e.g. Generic Public Subscription Identifier (GPSI)) or an external Group ID, in case the AF is located in the untrusted domain;
a SUPI or an internal Group ID, in case the AF is located within the trusted domain.

The GPSI may be an External Identifier for individual UE that includes the domain name. This domain name and the Application ID configured in the UE Application are different from each other.

Concerning a procedure for data collection from the UE Application, the AF can retrieve and store the Internet protocol (IP) address of the UE (e.g., in the PDU session used) in order to request data collection from the UE Application. The UE IP address is used by the AF to identify the user plane connection. Further, the UE Application can provide the Application ID configured in the UE Application to the AF as described in Technical Specification (TS) 26.531 [4].

Concerning AF registration and discovery, the AF can register its available NF profile to the Network Repository Function (NRF). The AF in trusted domain can register to the NRF by using the Nnrf_NFManagement service. The AF in untrusted domain can register the available NF profile to the NRF via the NEF.

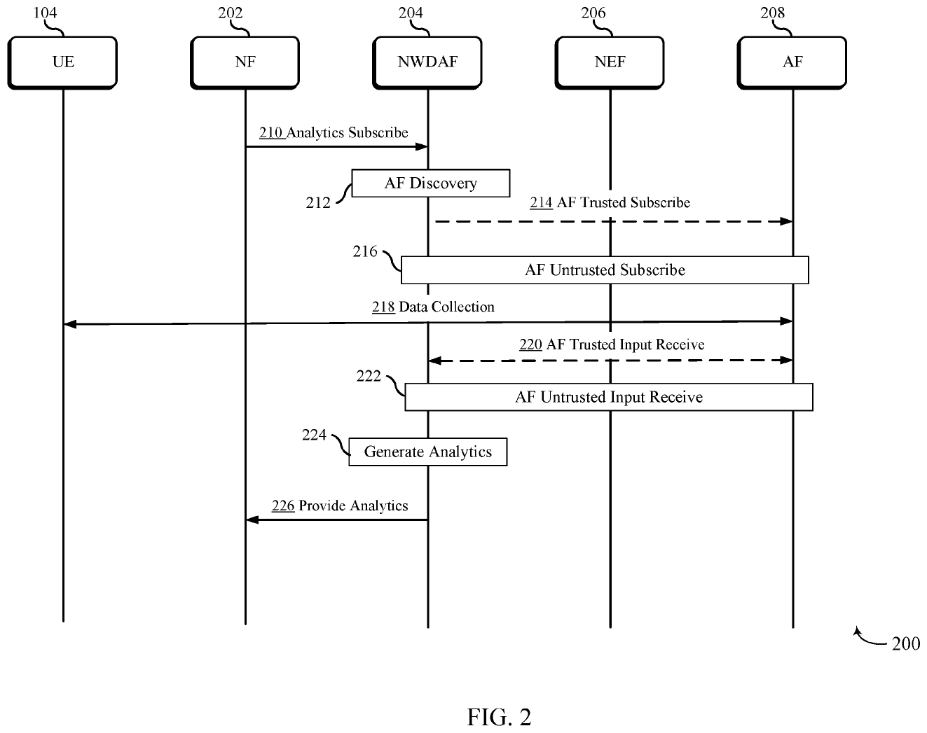

FIG. 2 illustrates a procedure 200 for data collection from a UE. The procedure 200 involves a UE 104, an NF 202, an NWDAF 204, an NEF 206, and an AF 208. At 210 the NF 202 subscribes to analytics from the NWDAF 204, that includes Analytics ID, Analytics Filter Information including, e.g. Aol, Internal Application ID(s) and Target of Analytics Reporting. The NWDAF 204 may also initiate the data collection prior to this subscription. In some scenarios subscription to analytics can be triggered directly towards the NWDAF 204 or can be done via Data Collection Coordination Function (DCCF). At 212 the NWDAF 204 discovers the AF 208 that provides data collection, e.g., based on AF profiles registered in NRF.

Step 214 is used for the AF 208 in trusted domain while step 216 is used for the AF in untrusted domain. At 214 the NWDAF 204 subscribes to the AF 208 in a trusted domain for UE data collection (e.g. input data from UE for analytics), by using Naf_EventExposure_Subscribe. The NWDAF request contains an Application ID known in the core network and the UE Application provides the Application ID configured in the UE Application. The AF 208 binds the NWDAF request for an Application ID and the UE data collection for an Application ID configured in the UE 104.

At 216 the NWDAF 204 subscribes to the AF 208 in an untrusted domain for UE data collection (e.g. input data from UE for analytics), e.g., by using steps 212-216. For steps 214, 216, data collection can also be triggered using DCCF.

At 218 the AF 208 collects the UE data using either direct or indirect data collection procedure. The establishment of the connection can be performed at any time prior to this. The AF 208 links the data collection request from step 3 to the user plane connection. In implementations a direct data collection and indirect data collection procedure is described in TS 26.531 [4].

Step 220 can be used for the AF 208 in trusted domain and step 222 used for the AF 208 in untrusted domain. At 220 the AF 208 in trusted domain receives the input data from the UE 104 and processes the data (e.g., anonymizes, aggregates, and normalizes) according to the SLA that is configured in the AF and Event ID(s) and Event Filter(s) set during step 214. The trusted AF 208 then notifies the NWDAF 2-4 on the processed data according to the NWDAF subscription in step 214.

At 222 the AF 208 in untrusted domain receives the input data from the UE 104 and processes the data (e.g., anonymizes, aggregates, and normalizes) according to the SLA that is configured in the AF 208 and Event ID(s) and Event Filter(s) set during step 216. The untrusted AF 208 notifies the NWDAF 204 on the processed data by using step 222.

In implementations, if the NWDAF 204 requests the same data from multiple UEs, e.g., a determined list of UEs or “any UE” as the Target of Analytics Reporting, the AF 208 can process (e.g., anonymize, aggregate, and normalize) the data from multiple UEs according to the Event ID(s) and Event Filter(s) received from NWDAF 204 during step 214 or 216 before notifying the NWDAF 204 on the processed data in step 220 (if the AF 208 is in trusted domain) or step 222 (if the AF is in untrusted domain).

At 224 the NWDAF 204 generates analytics using the UE data received from the AF 208 and at 226 the NWDAF 204 provides analytics to the consumer NF 202.

If the Target of Analytics Reporting that was received from the consumer at 210 includes an Internal Group ID, the NWDAF 204 includes such Internal Group ID in step 214 or step 216 to the AF 208. In the case of step 216, the NEF 206 translates the Internal Group ID to an External Group ID.

If the Target of Analytics Reporting that was received from consumer in step 210 is “any UE”, the NWDAF 204 may either set the target of event reporting to “any UE” in step 214 or 216 to the AF 208, or may determine a list of SUPIs from an AMF and/or Session Management Function (SMF) based on the Analytics Filter Information, and sends the SUPIs at step 214 or 216 to the AF 208 for the determined list of UEs. In implementations it can be assumed that the AF 208 is provisioned with the list of UE IDs (GPSIs or SUPIs) belonging to an External or Internal Group ID.

The following are some relevant definitions:
Application ID: A globally unique identifier identifying a specific application. This is the identifier used in mobile operating systems by the applications within the mobile operating system. All mobile operating systems have namespaces that identify the applications within the mobile operating system.
Destination Layer-2 ID: A link-layer identity that identifies a device or a group of devices that are recipients of ProSe communication frames.
ProSe Application ID: The ProSe Application ID is an identity used for open ProSe Direct Discovery, identifying application related information for the ProSe-enabled UE. Each ProSe Application ID could be globally unique.
ProSe Direct Communication: A communication between two or more UEs in proximity that are ProSe-enabled, by means of user plane transmission using Evolved Universal Terrestrial Radio Access (E-UTRA) technology via a path not traversing any network node.
ProSe Direct Discovery: A procedure employed by a ProSe-enabled UE to discover other ProSe-enabled UEs in its vicinity by using only the capabilities of the two UEs.
ProSe Discovery: A process that identifies that a UE that is ProSe-enabled is in proximity of another, using E-UTRA (with or without E-UTRAN), EPC or 5GS.
ProSe Discovery UE ID: A temporary identifier assigned by the ProSe Function in the Home Public Land Mobile Network (HPLMN) to the UE for the restricted direct discovery service. It includes the PLMN ID and a temporary identifier that uniquely identifies the UE in the HPLMN.
ProSe Function ID: An FQDN that identifies a ProSe Function.
ProSe Layer-2 Group ID: A layer-2 group identifier that may be used to address a set of users at the 3GPP lower layers. This ID needs to be configured in the UE before enabling one-to-many ProSe Direct Communication.
ProSe-enabled non-Public Safety UE: A UE that supports ProSe procedures but not capabilities specific to Public Safety.
ProSe-enabled Public Safety UE: A UE that the HPLMN has configured to be authorized for Public Safety use, and which is ProSe-enabled and supports ProSe procedures and capabilities specific to Public Safety. The UE may, but need not, have a Universal Subscriber Identity Module (USIM) with one of the special access classes.
ProSe-enabled UE: A UE that supports ProSe requirements and associated procedures. Unless explicitly stated otherwise, a Prose-enabled UE refers both to a non-Public Safety UE and a Public Safety UE.
ProSe UE-to-Network Relay: A UE that provides functionality to support connectivity to the network for Remote UE(s).
Relay Service Code: A Relay Service Code is used to identify a connectivity service the ProSe UE-to-Network Relay provides, and the authorized users the ProSe UE-to-Network Relay would offer service to, and may select the related security policies or information e.g. necessary for authentication and authorization between the Remote UE and the ProSe UE-to-Network Relay. The definition of values of Relay Service Code is out of scope of this specification.
Remote UE: A ProSe-enabled Public Safety UE that communicates with a PDN via a ProSe UE-to-Network Relay.
Restricted ProSe Application User ID: An identifier associated with the Application Layer User ID in the ProSe Application Server in order to hide/protect the application level user identity from the 3GPP layer. It unambiguously identifies the user within a given application. The format of this identifier is outside the scope of 3GPP.
Source Layer-2 ID: A link-layer identity that identifies a device that originates ProSe communication frames.

Accordingly, solutions are provided in this disclosure to support a UE to provide comprehensive suspicious behavior related data about other entities/functionalities such as UE-network relays, UEs (e.g., UEs involved in ProSe communication, V2X UEs, Uncrewed Aerial Systems (UAS), Uncrewed Aerial Vehicles (UAVs), UAV-Cs, network functions (NFs), etc., to enable an NWDAF and/or any related analytics functionality to detect cyber-attack(s) and other malicious and/or potentially malicious behavior. As used herein “suspicious behavior” can refer to behavior that exhibits characteristics of misbehavior, malicious behavior, and/or potential misbehavior and/or potential malicious behavior.

Implementations presented in this disclosure describe ways for a UE to collect malicious activity or misbehavior data associated to an entity such as another UE or relay involved in a direct communication with the UE (e.g., over PC5 interface) and reports to the network using either a control plane or user plane approach based on the operator's implementation.
(i) Example Case 1: A UE and a UE-network relay involved in a direct communication, where the UE-network relay acts suspiciously, and the UE performs reporting of suspicious behavior.
(ii) Example Case 2: A UE and a UE-network relay involved in a direct communication, where the UE acts suspiciously, and the UE-network relay performs reporting of suspicious behavior.
(iii) Example Case 3: Two UEs UE-1 and UE-2 involves in a direct communication (e.g., prose, V2X, U2X scenario), where the UE-1 acts suspiciously, and the UE-2 performs reporting of suspicious behavior. The vice versa is also contemplated.

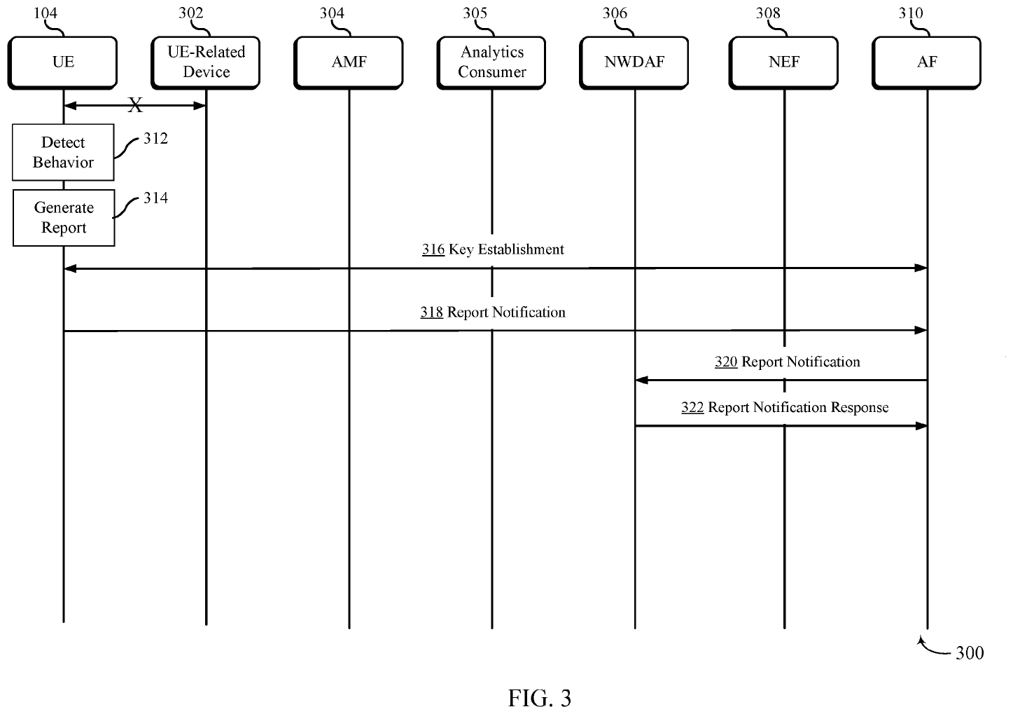

FIG. 3 illustrates a procedure 300 that supports suspicious behavior reporting in accordance with aspects of the present disclosure. The procedure 300, for instance, represents a malicious behavior related data collection procedure and/or a data collection procedure for cyber-attack detection. The procedure 300 includes a UE 104, a UE-related device 302, an AMF 304, an analytics consumer 305, an NWDAF 306, an NEF 308, and an AF 310. The UE-related device 302 represents an apparatus that can communicate with the UE 104, such as a UE-network relay, a UE (e.g., a UE involved in ProSe communication with the UE 104, a V2X UE, UAS, UAV, UAV-Cs, etc.), and so on. The analytics consumer 305 represents an apparatus associated with an entity that can utilize data and analytics pertaining to detected suspicious behavior, such as an Operations, Administration and Management/Maintenance (OAM) and/or other network function.

In implementations the UE 104 may be authenticated and registered to the network (e.g., 5G system). The UE 104 may be involved in a direct communication set up related message exchange or have already set up a direct communication link (e.g., over PC5) with the UE-related device 302, e.g., related to D2D such as V2X or U2X scenarios or a “UE-network relay”, e.g., Proximity-based Services (ProSe). A ‘UE to network relay’ can be a UE that provides functionality to support connectivity to the network for Remote UE(s).

At 312 the UE 104 determines that the UE-related device 302 involved in the direct communication with the UE 104 exhibits suspicious behavior. The UE 104 can detect suspicious behavior in various ways, such as if the UE-related device violates a normal behavior and/or expected behavior such as listed below:
if the UE-related device 302 involved in the direct communication repeatedly causes direct communication link failure;
if any of the message exchange related to direct communication contains traffic and/or data which deviates from an expected/configured message exchange protocol/format;
if the UE-related device 302 executes any unknown operation that cannot be recognized by the UE 104;
if the UE-related device 302 attempts perform an operation that exceeds a threshold, e.g., flooding of data which exceeds a configured limit and/or processing capability of the UE 104;
if the UE 104 identifies an error in the direct communication set up procedure which is run with the UE-related device 302:
if the UE 104 identifies an error in the direct communication link that is established with the UE-related device 302.

At 314 the UE 104 generates a suspicious behavior report. In implementations where the UE-related device 302 involved in the direct communication is a UE-to-network relay, the UE 104 can generate the suspicious behavior report to include one or more of an event ID (e.g., that indicates a suspicious behavior or a specific suspicious behavior type), Source ID (e.g., UE ID, which can be SUPI/GPSI), Source application ID (e.g., announcer info such as prose application ID), Source Layer-2 ID, ProSe Relay UE ID, Relay Service Code, Destination Layer-2 ID, ProSe Layer-2 Group ID, a UE ID related to the destination UE/UE-to network relay (e.g., Restricted ProSe Application User ID, ProSe Discovery UE ID), EUTRAN Cell Global ID (ECGI) and/or any network related Cell Global ID, Traffic telemetry data, Serving Prose/V2X/U2X function ID, Serving Prose/V2X/U2X function address, and Timestamp (e.g., time at which the report was created or a malicious behavior detected).

Some general definitions related to ProSe includes the following:
ProSe UE ID: link layer identifier that is used for subsequent direct one-to-one and one-to-many communication.
Relay Service Code: the Relay Service Code associated with the message. The Relay Service Code is used to identify the security parameters needed by the receiving UE to process the discovery message
ProSe Relay UE ID: link layer identifier that is used for direct communication and is associated with a Relay Service Code.
ECGI or a cell group ID: indicates the serving cell of the ProSe UE-to-Network Relay.

In implementations where the UE-related device 104 involved in the direct communication is a different UE, the UE 104 can generate the suspicious behavior report to include one or more of an event ID (e.g., that indicates a misbehavior or a specific misbehavior type), Source ID (e.g., UE ID, which can be SUPI/GPSI), Source application ID (e.g., related to V2X service/U2X service or any other service), Source Layer-2 ID, Destination Layer-2 ID, Layer-2 Group ID, a network related Cell Global ID, Destination UE ID (e.g., V2X ID or any UAV-ID/UAV-C ID), Traffic telemetry data, Serving Prose/V2X/U2X function ID, Serving Prose/V2X/U2X function address, and Timestamp, e.g., time at which the report was created or a malicious behavior detected.

At 316 the UE 104 can set up an application session (e.g., with an application session establishment request and response procedure based on Authentication and Key Management for Applications (AKMA) or Generic Bootstrapping Architecture (GBA)) with the AF 310 based on the local configuration related to the AF ID, AF address, and/or FQDN. At 318 the UE 104 sends the suspicious behavior report to the AF 310 using the application session to perform suspicious behavior report notification.

In this particular implementation consider that the AF 310 is within a trusted domain of a network operator for the UE 104. Accordingly, at 320 the AF 310 sends to the NWDAF 306 a report notification (e.g., a Naf_Event_Exposure Notify message) which includes the suspicious behavior report, e.g., as generated by the UE 104. At 322 the NWDAF 306 sends to the AF 310 a report notification response (e.g., a Naf_Event_Exposure Notify response message) with a suspicious behavior report acknowledgement indication. Alternatively or additionally, the NWDAF 306 sends to the AF 310 an Naf_Event_Exposure Notify acknowledgement message.

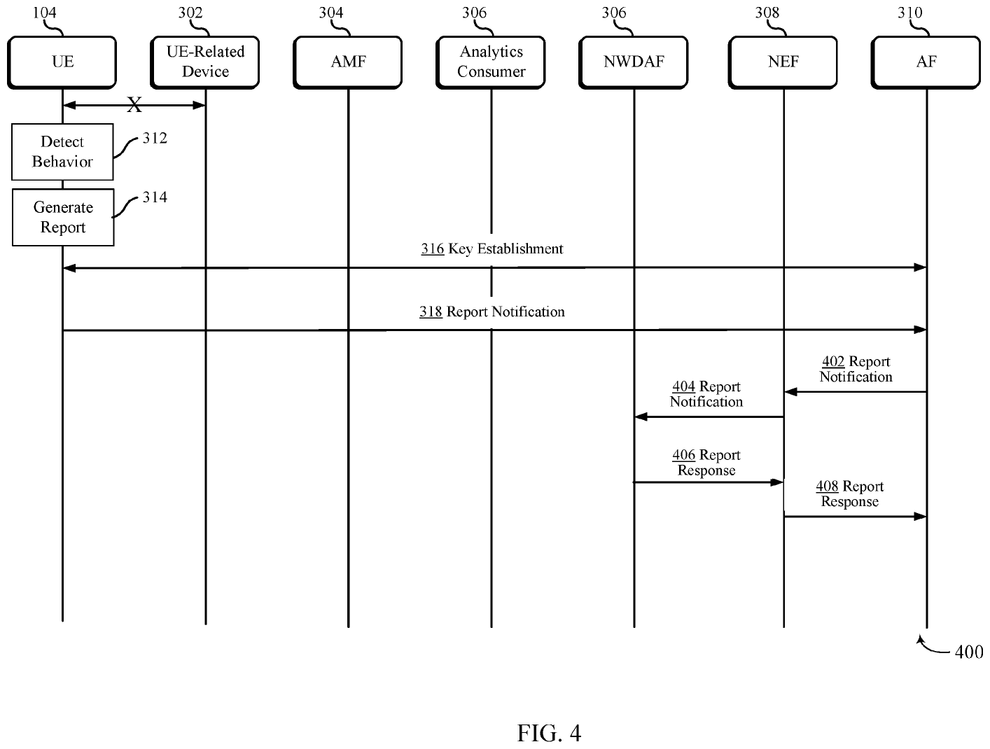

FIG. 4 illustrates a procedure 400 that supports suspicious behavior reporting in accordance with aspects of the present disclosure. The procedure 400, for instance, represents a malicious behavior related data collection procedure and/or a data collection procedure for cyber-attack detection where the AF 310 is outside of a trusted domain and/or the AF 310 is within an untrusted domain. The procedure 400 incorporates various aspects of the procedure 300 and can be implemented as an additional or alternative implementation to the procedure 300.

In the procedure 400, steps 312, 314, 316, 318 are implemented such as described above. At 402 the AF 310 sends to the NEF 308 a report notification (e.g., Naf_Event_Exposure Notify message) which includes the suspicious behavior report such as received from the UE 104. At 404 the NEF 308 sends to the NWDAF 306 a report notification, e.g., a suspicious behavior report in a Nnef_Event_Exposure Notify message. At 406 the NWDAF 306 sends to the NEF 308 a report response, e.g., an Nnef_Event_Exposure Notify response message with a suspicious behavior report acknowledgement indication. Alternatively or additionally, the NWDAF 306 sends to the NEF 308 an Nnef_Event_Exposure Notify acknowledgement message.

At 408 the NEF 308 sends to the AF 310 a report response, e.g., the Naf_Event_Exposure Notify response message with a suspicious behavior report acknowledgement indication. Alternatively or additionally, the NEF 308 sends to the AF 310 an Naf_Event_Exposure Notify acknowledgement message.

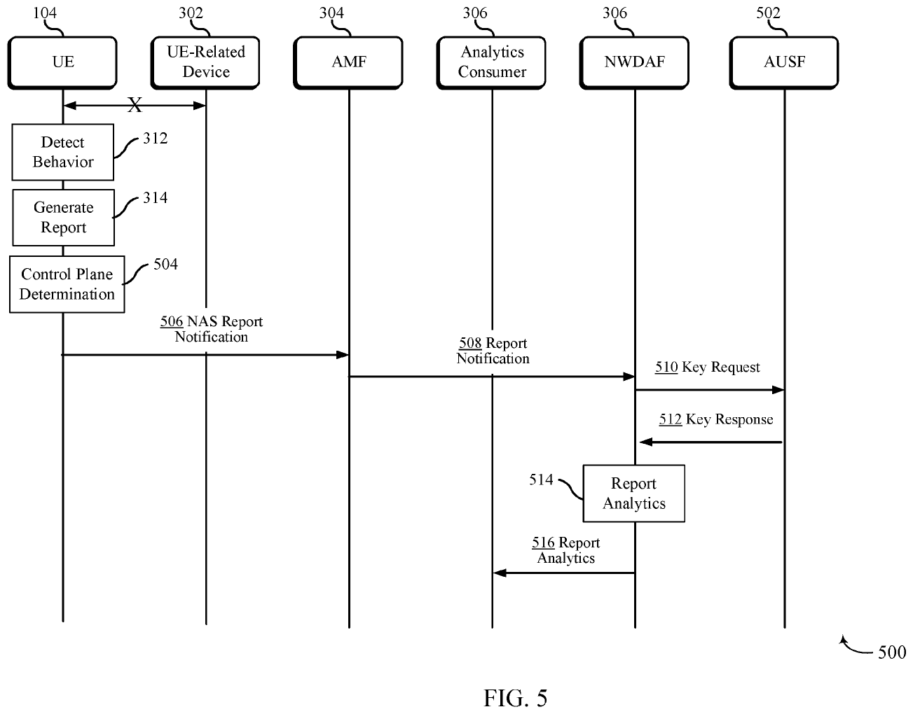

FIG. 5 illustrates a procedure 500 that supports suspicious behavior reporting in accordance with aspects of the present disclosure. The procedure 500, for instance, represents a malicious behavior related data collection procedure and/or a data collection procedure for cyber-attack detection where the UE 104 uses a control plane for reporting. The procedure 500 incorporates various aspects of the procedures 300, 400 and can be implemented as an additional or alternative implementation to the procedures 300, 400. Further, the procedure 500 includes an Authentication Server Function (AUSF) 502.

In the procedure 500, steps 312, 314, are implemented such as described above. At 504 the UE 104 determines to send the suspicious behavior report using the control plane (e.g., via NAS) in clear text (e.g., the UE may also receive a suspicious behavior report request from the NWDAF via the serving AMF and then the UE determines to send the report using the control plane). Alternatively or additionally, the UE 104 derives a reporting security key from the Kausf and/or Kakma to protect the generated suspicious behavior report if the UE 104 is configured to send a secured suspicious behavior report. The UE 104 can derive the reporting security key as follows: Reporting security Key: Key Derivation Function (KDF) (Kakma (or) Kausf, Input parameter(s): Event ID (e.g., that indicates a misbehavior or a specific misbehavior type), UE ID (e.g., SUPI/GPSI), freshness parameter (e.g., nonce/random number)).

The UE 104 may encrypt the misbehavior report or just integrity protect the misbehavior report using the reporting security key or from a key derived from the reporting key. If both confidentiality and integrity protection are to be implemented, confidentiality and integrity protection keys can be generated from the reporting security key using an additional parameter ‘a code e.g., 0x0000’ specific to the confidentiality and ‘a code e.g., 0x0001’ specific to the integrity protection.

At 506 the UE 104 sends the suspicious behavior report to the serving AMF 304 over an NAS message. Alternatively or additionally, the UE 104 sends the suspicious behavior report (optionally in encrypted form if encrypted else in clear text if not encrypted), freshness parameter, SUPI, a message authentication code (MAC generated for the integrity protection of the misbehavior report).

At 508 the AMF 304 forwards/sends to the NWDAF 306 (e.g., based on local configuration or based on the analytics event exposure subscription), the suspicious behavior report received previously, e.g., in an Namf_event_exposure_notify message. Alternatively or additionally, the AMF 304 forwards/sends to the NWDAF 306 the received suspicious behavior report (optionally in encrypted form if encrypted else in clear text if not encrypted), freshness parameter, SUPI, MAC in an Namf_event_exposure_notify message.

In implementations, steps 510, 512 can be implemented by the NWDAF 306 if the NWDAF 306 receives the suspicious behavior report with confidentiality and/or integrity protection (e.g., with a MAC and/or with an encrypted the suspicious behavior report). For instance, at 510 the NWDAF 306 sends a key request to the AUSF 502 (e.g., based on the local configuration and/or operator's implementation), where the key request includes SUPI, Event ID, and freshness parameter. The AUSF 502 can derive the reporting security key using the received input parameters similar to the reporting security key generation performed by the UE in step 504.

At 512 the AUSF provides the reporting security key (Rsk) to the NWDAF 306 in a Key response message. At 514 the NWDAF 306 performs analytics over data from the suspicious behavior report and at 516 provides the analytics to the analytics consumer 305.

According to various implementations, the procedures 300, 400, 500 can be implemented as additions and/or alternatives for implementing the various techniques described herein.

TABLE 1
Inputs provided by a UE and available in a suspicious behavior report

| Information | Description |
|---|---|
| Event ID | Indicates a misbehavior or a specific misbehavior type |
| Timestamp | A timestamp associated with the misbehavior report |
| Source UE identification | One or more IDs related to the reporting UE |
| information | |
| Destination UE identification | One or more IDs related to the UE which is suspected to |
| information | misbehaved |
| Group ID | IDs of one or more UEs who are part of the group in which |
| | the misbehaved UE offers a service or consumes a service. |
| Destination UE Type | The capability of the UE e.g., normal UE or a UE to |
| | network relay/or a relay node |
| Traffic Telemetry Data | The traffic data collected by the source UE from the |
| | destination UE |
| Service Type and Service | The type of service being used between the source UE |
| specific information | and destination UE (e.g., Prose/V2X/U2X) |
| Application ID | The application ID of the service |
| Cell level information | Any cell level information such as Cell global ID |
| Serving function information | The function in the core network which coordinated the |
| | service between the source UE and the destination UE |
| | (e.g., a prose function, V2X function or U2X function) |

TABLE 2
Cyber-attack or UE malicious behavior related analytics/statistics

| Information | Description |
|---|---|
| Exceptions | List of observed exceptions |
| (1 . . . max) | |
| > Exception ID | The risk detected by NWDAF |
| > Exception category | Indication if the misbehaviour behaviour is a cyber-attack, or a |
| | different type of attack or genuine error |
| > Exception level | Scalar value indicating the severity of the misbehavior |
| > List of UE(s) | One or more UEs or UE-network-relays which are affected |
| | due to the misbehavior of the UE or the UE-network relay in |
| | the system |
| > List of malicious or | One or more UE(s) and/or UE-network relay(s) which are the |
| misbehaving UE(s) | probable cause of the misbehavior activity in the system |
| and/or UE-network | (either because they are malicious or due to internal errors) |
| relay(s) | |
| > Exception category | Indication if the misbehaviour is an attack or genuine error |

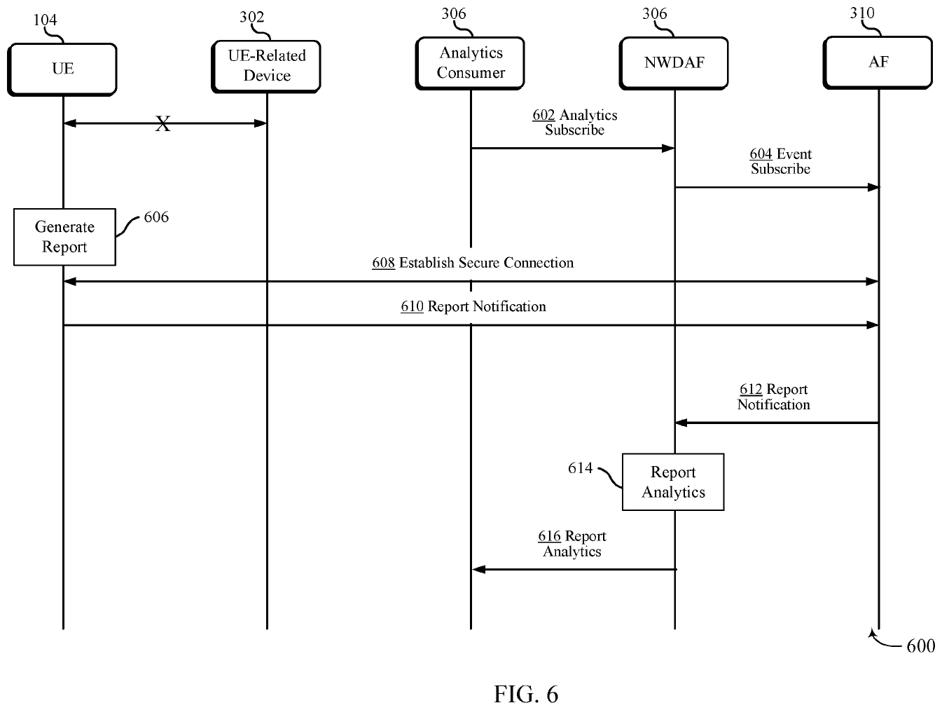

FIG. 6 illustrates a procedure 600 that supports suspicious behavior reporting in accordance with aspects of the present disclosure. The procedure 600, for instance, represents a malicious behavior related data collection procedure and/or a data collection procedure for cyber-attack detection. The procedure 600 incorporates various aspects of the procedures 300-500 and can be implemented as an additional or alternative implementation to the procedures 300-500.

In at least one implementation the UE 104 is registered to the network. The UE 104 may be involved in a direct communication set up related message exchange or have already set up a direct communication link (e.g., over PC5) with the UE-related device 302.

At 602 the analytics consumer 305 subscribes to the UE malicious behavior (or misbehavior) related analytics information, such as by invoking the Nnwdaf_Analytics_Subscription_Subscribe service operation message, with the analytics ID (set to the malicious UE behavior analytics/cyber-attack detection analytics/attack detection analytics), list of event ID(s) (related to malicious UE behavior, UE suspicious behavior report, cyber-attacks, threats, DoS, DDoS, received messages (e.g., malformed messages) violating predefined service operation input or output formats, message requests exceeding configured limits, unintended or unrecognized configuration change/operational change, any errors notification, repeated authentication failure, repeated communication failure etc.,), target of analytics (indicates one or more UE IDs such as SUPIs/GPSIs/relay IDs).

At 604 the NWDAF 306 based on local configuration subscribes to the AF 310 for the event exposure services (e.g., via NEF if the AF is located externally) to be notified for data on event related to UE misbehavior report (additional event IDs may be indicated based on step 1) and includes target of reporting as one or more UEs (identified with SUPI or GPSI).

At 606 the UE 104 determines that the UE-related device 302 involved in the direct communication is suspected to exhibit suspicious behavior (e.g., violates a normal behavior) such as listed below:
if the UE-related device 302 involved in the direct communication repeatedly causes direct communication link failure;
if any of the message exchange related to direct communication contains traffic and/or data which deviates from an expected/configured message exchange protocol/format;
if the UE-related device 302 executes any unknown operation that cannot be recognized by the UE 104;
if the UE-related device 302 attempts perform an operation that exceeds a threshold, e.g., flooding of data which exceeds a configured limit and/or processing capability of the UE 104;
if the UE 104 identifies an error in the direct communication set up procedure which is run with the UE-related device 302:
if the UE 104 identifies an error in the direct communication link that is established with the UE-related device 302.

At 606 the UE 104 generates a suspicious behavior report with one or more of event ID (related to the UE misbehavior report), source identity(ies) (e.g., SUPI/GPSI, source layer-2 ID, application level ID), target identity(ies) (e.g., destination layer-2 ID, application level ID of the UE or relay UE ID of the UE-network relay (e.g., based on the type of destination device)), application ID, traffic telemetry data (e.g., data collected by the UE from the other UE/UE-network relay, which includes the suspicious data/message that violate the normal behavior), serving prose/v2x/u2x function ID, and timestamp. Alternatively or additionally, for cases where the UE-network relay experiences misbehavior from another UE, in the UE suspicious behavior report, the source identities can be related to the relay UE and the destination identities can be that of the other misbehaving UE.

At 608, 610 the UE 104 implements setup of an application session with the AF 310 based on the local configuration (e.g., using AF ID (e.g., with FQDN)) and sets up a secure connection based on AKMA. The UE 104 further provides the suspicious behavior report to the AF over established the application session.

At 612 the AF 310 sends to the NWDAF 306 a report notification (e.g., the Naf_Event_Exposure Notify message) which includes the suspicious behavior report, e.g., received from the UE at 610. In at least one implementation the AF 310 notifies the suspicious behavior report to the NWDAF 306 via an NEF if the AF 310 is located externally to the network.

At 614 the NWDAF 306 performs UE suspicious event specific analytics (e.g., cyber-attack detection analytics), such as by using the data collected and received in the suspicious behavior report. At 616 the NWDAF 306 notifies the analytics consumer 305 (e.g., using the Nnwdaf_AnalyticsSubscription_Notify and/or Nnwdaf_Analytics_Info-Request response (e.g., based on the request)) of Analytics Reporting Parameters which include event specific UE malicious behavior analytics and/or cyber-attack detection analytics related statistics and prediction output, such as shown in Tables 3 and 4 below, respectively.

TABLE 3
UE misbehaviour/malicious behaviour Statistics

| Information | Description |
|---|---|
| Exceptions | List of observed exceptions |
| (1 . . . max) | |
| > Exception ID | The risk detected by NWDAF |
| > Exception Level | Scalar value indicating the severity of the |
| | misbehaviour or abnormal/malicious |
| | behaviour |
| > Exception trend | Measured trend (up/down/unknown/stable) |
| > Cause | Indicates the cause for the exception and |
| | alerts such as configuration issues, type of |
| | attack (e.g., related to malicious behavior, |
| | cyber-attack/DOS/DDOS or any other)/threat, |
| | malfunction, overload, software issues, or |
| | issues with service (Prose/V2X/U2X) specific |
| | information accordingly. |
| > List of | UE Identification information (i.e., UE IDs) |
| malicious/misbehaving | related to UEs and UE-network relays that are |
| UEs | identified as malicious UEs/misbehaving UEs |
| > List of impacted | UE Identification information (i.e., UE IDs) |
| UEs and relays | related to UEs and UE-network relays |
| | impacted due to the UE malicious |
| | behaviour/Cyber-attack/Exceptions. |
| > Amount of UE | Estimated number of UEs affected by the |
| | Exception |
| > Amount of | Estimated number of Relay/UE-network relay |
| Relay/UE-network | affected by the Exception |
| relay | |
| > Exception category | Indication if the UE/relay misbehaviour is an |
| | attack or genuine error |

TABLE 4
UE misbehaviour/malicious behaviour Predictions

| Information | Description |
|---|---|
| Exceptions | List of predicted exceptions |
| (1 . . . max) | |
| > Exception ID | The risk detected by NWDAF |
| > Exception Level | Scalar value indicating the severity of the |
| | misbehaviour or abnormal/malicious behaviour |
| > Exception trend | Measured trend (up/down/unknown/stable) |
| > Cause | Indicates the cause for the exception and |
| | alerts such as configuration issues, type of |
| | attack (e.g., related to malicious behavior, |
| | cyber-attack/DOS/DDOS or any other)/threat, |
| | malfunction, overload, software issues, or |
| | issues with service (Prose/V2X/U2X) specific |
| | information accordingly. |
| > List of | UE Identification information (i.e., UE IDs) |
| malicious/misbehaving | related to UEs and UE-network relays that are |
| UEs | identified as malicious UEs/misbehaving UEs |
| > List of impacted | UE Identification information (i.e., UE IDs) |
| UEs and relays | related to UEs and UE-network relays |
| | impacted due to the UE malicious |
| | behaviour/Cyber-attack/Exceptions. |
| > Amount of UE | Estimated number of UEs affected by the |
| | Exception |
| > Amount of | Estimated number of Relay/UE-network relay |
| Relay/UE-network | affected by the Exception |
| relay | |
| > Exception | Indication if the UE/relay misbehaviour is an |
| category | attack or genuine error |
| > Confidence | Confidence of this prediction |

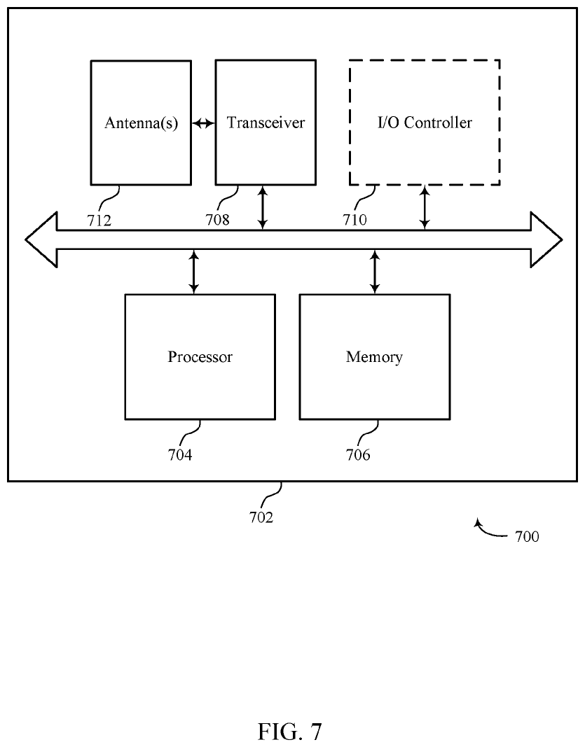

FIG. 7 illustrates an example of a block diagram 700 of a device 702 (e.g., an apparatus) that supports suspicious behavior reporting in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to generate suspicious behavior data based on detected suspicious behavior pertaining to a direct communication of a second apparatus with the first apparatus, the suspicious behavior data including an event identifier, a timestamp, and one or more of an event identifier, the identifier for the second apparatus, an application identifier, a service type, service function information, an identifier for the first apparatus, a destination relay identifier, or traffic telemetry data; generate a suspicious behavior report including at least some of the suspicious behavior data; and transmit the suspicious behavior report.

Further, in some implementations, the suspicious behavior includes one or more of misbehavior pertaining to the direct communication, malicious behavior pertaining to the direct communication, or suspected malicious behavior pertaining to the direct communication; the processor is configured to cause the first apparatus to collect the traffic telemetry data from the second apparatus, and the traffic telemetry data includes one or more of suspicious data or a suspicious message; the first apparatus includes a first user equipment (UE) and the second apparatus includes one or more of a second UE, a UE-network relay, or a relay node; the processor is configured to cause the apparatus to detect the suspicious behavior based on at least one of: the second apparatus causes multiple direct communication link failures; a message exchange pertaining to the direct communication includes one or more of traffic or data which deviates from at least one of a standard message exchange protocol or a standard message exchange format; the second apparatus executes an operation unrecognized by the first apparatus; the second apparatus transmits data which exceeds a threshold; a detected error in a direct communication set up procedure which is implemented with the second apparatus; or a detected error in a direct communication link that is established with the second apparatus; the threshold pertains to one or more of a configured limit or a processing capability.

Further, in some implementations, the identifier for the second apparatus includes one or more of a destination ProSe relay UE identifier, a destination Layer-2 identifier, or a ProSe Layer-2 group identifier; the identifier for the first apparatus includes one or more of a source ProSe relay UE identifier, a source Layer-2 identifier, or a ProSe Group identifier; the service type includes at least one of ProSe, U2X, or V2X; the processor is configured to cause the first apparatus to transmit in the suspicious behavior report the information (e.g., identifier or address) about at least one serving function, and in the at least one serving function includes one or more of a ProSe service function, a U2X service function, or a V2X service function; the processor is configured to cause the first apparatus to: determine to transmit the suspicious behavior report using a control plane; and transmit the suspicious behavior report to an Access and Mobility Management Function (AMF) over Non-Access Stratum (NAS) transport; the processor is configured to cause the first apparatus to: determine to transmit the suspicious behavior report using a user plane; and transmit the suspicious behavior report to an AF; to determine to transmit the suspicious behavior report using a user plane, the processor is configured to cause the first apparatus to determine the transmit the suspicious behavior report using an application-level connection.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

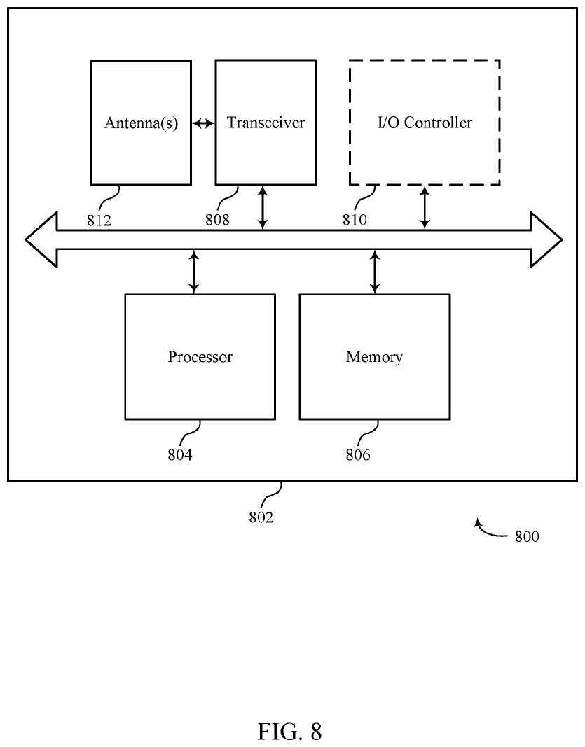

FIG. 8 illustrates an example of a block diagram 800 of a device 802 (e.g., an apparatus) that supports suspicious behavior reporting in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of network entity 102, for example, the transceiver 808 and the processor 804 coupled to the transceiver 808 are configured to cause the network entity 102 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to receive a suspicious behavior report including suspicious behavior data based on detected suspicious behavior pertaining to a direct communication between a second apparatus and a third apparatus, the suspicious behavior data including an event identifier, a timestamp, and one or more of an event identifier, a source identifier for the second apparatus, an application identifier, a service type, service function information, an identifier for the first apparatus, a destination relay identifier, or traffic telemetry data; and transmit the suspicious behavior report to a fourth apparatus.

Further, in some implementations, the first apparatus includes an AF, the second apparatus includes a first user equipment (UE) that generates the suspicious behavior report, and the third apparatus includes one or more of a second UE, a UE-network relay, or a relay node that causes behavior described by at least some of the suspicious behavior data; the fourth apparatus includes at least one of a NWDAF or a NEF; the processor is configured to cause the first apparatus to receive, from the fourth apparatus, an acknowledgement message based at least in part on the suspicious behavior report.

In a further example, the processor 804 and/or the transceiver 808 may support wireless communication at the device 802 in accordance with examples as disclosed herein. The processor 804 and/or the transceiver 808, for instance, may be configured as or otherwise support a means to receive, from a second apparatus, a suspicious behavior report including suspicious behavior data based on detected suspicious behavior pertaining to a direct communication between a third apparatus and a fourth apparatus; and transmit, based at least in part on the suspicious behavior report, an acknowledgement message to the second apparatus.

Further, in some implementations, the first apparatus includes a NWDAF, the second apparatus includes at least one of an AF or a NEF, the third apparatus includes a first user equipment (UE) that generates at least some of the suspicious behavior data, and the fourth apparatus includes one or more of a second UE, a UE-network relay, or a relay node that causes behavior described by the at least some of the suspicious behavior data; the suspicious behavior data includes an event identifier, a timestamp, and one or more of an event identifier, a source identifier for the fourth apparatus, an application identifier, a service type, service function information, an identifier for the third apparatus, a destination relay identifier, or traffic telemetry data; the suspicious behavior data includes an event identifier, a timestamp, and one or more of an event identifier, the identifier for the second apparatus, an application identifier, a service type, service function information, an identifier for the first apparatus, a destination relay identifier, or traffic telemetry data; the processor is configured to cause the first apparatus to output analytics data including one or more of a list of observed exceptions, a detected risk, an attack type associated with the suspicious behavior data, an indication of a severity of the suspicious behavior, a list of one or more UE-related devices suspected to be a cause of the suspicious behavior, a list of one or more UE-related devices suspected to be impacted due to other UE's suspicious behavior, or an indication of a confidence value pertaining to the suspicious behavior.

In a further example, the processor 804 and/or the transceiver 808 may support wireless communication at the device 802 in accordance with examples as disclosed herein. The processor 804 and/or the transceiver 808, for instance, may be configured as or otherwise support a means to receive, from a second apparatus and over Non-Access Stratum (NAS) transport, a suspicious behavior report including suspicious behavior data based on detected suspicious behavior pertaining to a direct communication between the second apparatus and a third apparatus; and transmit the suspicious behavior report to a fourth apparatus.

Further, in some implementations, the first apparatus includes an Access and Mobility Management Function (AMF), the second apparatus includes a first user equipment (UE) that generates at least some of the suspicious behavior data, the third apparatus includes one or more of a second UE, a UE-network relay, or a relay node that causes behavior described by the at least some of the suspicious behavior data, and the fourth apparatus includes a NWDAF; the processor is configured to cause the first apparatus to: receive, from the second apparatus and pertaining to the suspicious behavior report, one or more of a freshness parameter, a SUPI, or a MAC; and transmit, to the fourth apparatus, one or more of the freshness parameter, the SUPI, or the MAC.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

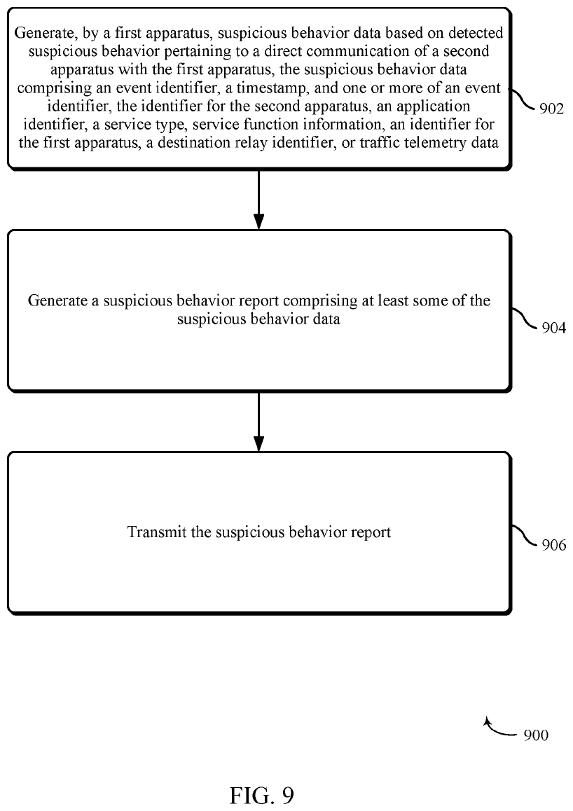

FIG. 9 illustrates a flowchart of a method 900 that supports suspicious behavior reporting in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include generating, by a first apparatus, suspicious behavior data based on detected suspicious behavior pertaining to a direct communication of a second apparatus with the first apparatus, the suspicious behavior data comprising an event identifier, a timestamp, and one or more of an event identifier, the identifier for the second apparatus, an application identifier, a service type, service function information, an identifier for the first apparatus, a destination relay identifier, or traffic telemetry data. The operations of 902 may be performed in accordance with examples as described herein. In some implementations, aspects of the operations of 902 may be performed by a device as described with reference to FIG. 1.

At 904, the method may include generating a suspicious behavior report comprising at least some of the suspicious behavior data. The operations of 904 may be performed in accordance with examples as described herein. In some implementations, aspects of the operations of 904 may be performed by a device as described with reference to FIG. 1.

At 906, the method may include transmitting the suspicious behavior report. The operations of 906 may be performed in accordance with examples as described herein. In some implementations, aspects of the operations of 906 may be performed by a device as described with reference to FIG. 1.

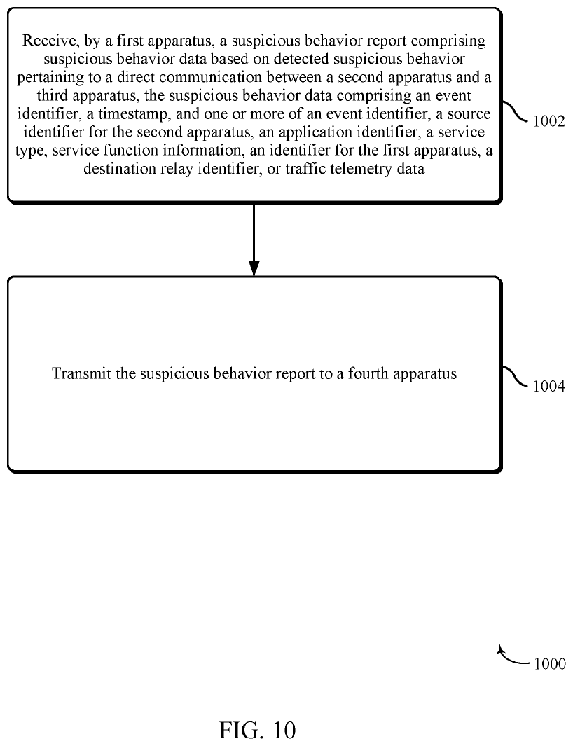

FIG. 10 illustrates a flowchart of a method 1000 that supports suspicious behavior reporting in accordance with aspects of the present disclosure. The operations of the method 1000 may be implemented by a device or its components as described herein. For example, the operations of the method 1000 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include receiving, by a first apparatus, a suspicious behavior report comprising suspicious behavior data based on detected suspicious behavior pertaining to a direct communication between a second apparatus and a third apparatus, the suspicious behavior data comprising an event identifier, a timestamp, and one or more of an event identifier, a source identifier for the second apparatus, an application identifier, a service type, service function information, an identifier for the first apparatus, a destination relay identifier, or traffic telemetry data. The operations of 1002 may be performed in accordance with examples as described herein. In some implementations, aspects of the operations of 1002 may be performed by a device as described with reference to FIG. 1.

At 1004, the method may include transmitting the suspicious behavior report to a fourth apparatus. The operations of 1004 may be performed in accordance with examples as described herein. In some implementations, aspects of the operations of 1004 may be performed by a device as described with reference to FIG. 1.

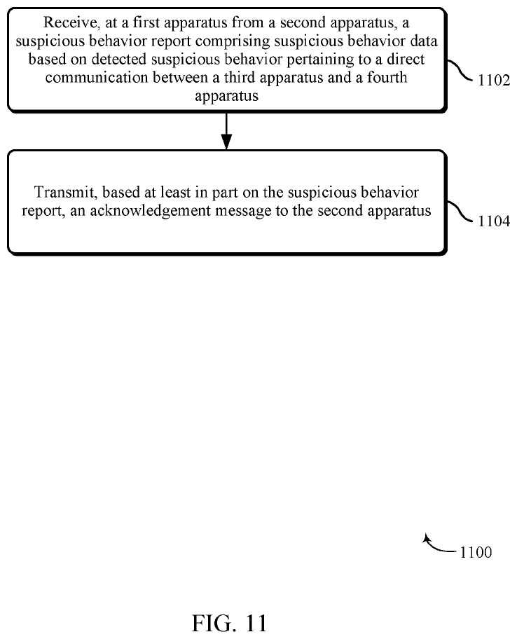

FIG. 11 illustrates a flowchart of a method 1100 that supports suspicious behavior reporting in accordance with aspects of the present disclosure. The operations of the method 1100 may be implemented by a device or its components as described herein. For example, the operations of the method 1100 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving, at a first apparatus from a second apparatus, a suspicious behavior report comprising suspicious behavior data based on detected suspicious behavior pertaining to a direct communication between a third apparatus and a fourth apparatus. The operations of 1102 may be performed in accordance with examples as described herein. In some implementations, aspects of the operations of 1102 may be performed by a device as described with reference to FIG. 1.

At 1104, the method may include transmitting, based at least in part on the suspicious behavior report, an acknowledgement message to the second apparatus. The operations of 1104 may be performed in accordance with examples as described herein. In some implementations, aspects of the operations of 1104 may be performed by a device as described with reference to FIG. 1.

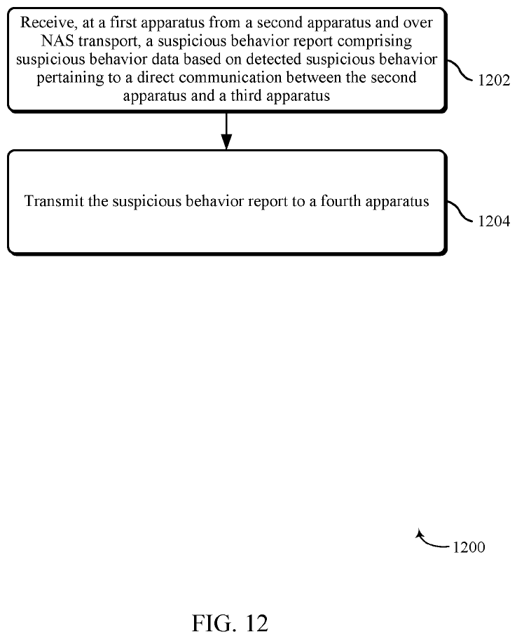

FIG. 12 illustrates a flowchart of a method 1200 that supports suspicious behavior reporting in accordance with aspects of the present disclosure. The operations of the method 1200 may be implemented by a device or its components as described herein. For example, the operations of the method 1200 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include receiving, at a first apparatus from a second apparatus and over Non-Access Stratum (NAS) transport, a suspicious behavior report comprising suspicious behavior data based on detected suspicious behavior pertaining to a direct communication between the second apparatus and a third apparatus. The operations of 1202 may be performed in accordance with examples as described herein. In some implementations, aspects of the operations of 1202 may be performed by a device as described with reference to FIG. 1.

At 1204, the method may include transmitting the suspicious behavior report to a fourth apparatus. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured operable to cause the UE to:
generate suspicious behavior data based on detected suspicious behavior pertaining to a direct communication of a second apparatus with the UE, the suspicious behavior data comprising an event identifier, a timestamp, and one or more of an event identifier, the identifier for the second apparatus, an application identifier, a service type, service function information, an identifier for the UE, a destination relay identifier, or traffic telemetry data;
generate a suspicious behavior report comprising at least some of the suspicious behavior data; and
transmit the suspicious behavior report.

2. The UE of claim 1, wherein the suspicious behavior comprises one or more of misbehavior pertaining to the direct communication, malicious behavior pertaining to the direct communication, or suspected malicious behavior pertaining to the direct communication.

3. The UE of claim 1, wherein the at least one processor is operable to cause the UE to collect the traffic telemetry data from the second apparatus, and the traffic telemetry data comprises one or more of suspicious data or a suspicious message.

4. The UE of claim 1, wherein the second apparatus comprises one or more of a second UE, a UE-network relay, or a relay node.

5. The UE of claim 1, wherein the at least one processor is operable to cause the UE to detect the suspicious behavior based on at least one of:
the second apparatus causes multiple direct communication link failures;
a message exchange pertaining to the direct communication comprises one or more of traffic or data which deviates from at least one of a standard message exchange protocol or a standard message exchange format;
the second apparatus executes an operation unrecognized by the UE;
the second apparatus transmits data which exceeds a threshold;
a detected error in a direct communication set up procedure which is implemented with the second apparatus; or
a detected error in a direct communication link that is established with the second apparatus.

6. The UE of claim 5, wherein the threshold pertains to one or more of a configured limit or a processing capability.

7. The UE of claim 1, wherein the identifier for the second apparatus comprises one or more of a destination ProSe relay UE identifier, a destination Layer-2 identifier, or a ProSe Layer-2 group identifier.

8. The UE of claim 1, wherein the identifier for the UE comprises one or more of a source ProSe relay UE identifier, a source Layer-2 identifier, or a ProSe Group identifier.

9. The UE of claim 1, wherein the service type comprises at least one of ProSe, U2X, or V2X.

10. The UE of claim 1, wherein the at least one processor is operable to cause the UE to transmit in the suspicious behavior report the information (e.g., identifier or address) about at least one serving function, and wherein the at least one serving function comprises one or more of a ProSe service function, a U2X service function, or a V2X service function.

11. The UE of claim 1, wherein the at least one processor is operable to cause the UE to:
determine to transmit the suspicious behavior report using a control plane; and
transmit the suspicious behavior report to an Access and Mobility Management Function (AMF) over Non-Access Stratum (NAS) transport.

12. The UE of claim 1, wherein the at least one processor is operable to cause the UE to:
determine to transmit the suspicious behavior report using a user plane; and
transmit the suspicious behavior report to an Application Function (AF).

13. The UE of claim 12, wherein to determine to transmit the suspicious behavior report using a user plane, the at least one processor is operable to cause the UE to determine the transmit the suspicious behavior report using an application-level connection.

14. (canceled)

15. (canceled)

16. (canceled)

17. (canceled)

18. (canceled)

19. A method performed by a user equipment (UE), the method comprising:
generating suspicious behavior data based on detected suspicious behavior pertaining to a direct communication of a second apparatus with the UE, the suspicious behavior data comprising an event identifier, a timestamp, and one or more of an event identifier, the identifier for the second apparatus, an application identifier, a service type, service function information, an identifier for the UE, a destination relay identifier, or traffic telemetry data;
generating a suspicious behavior report comprising at least some of the suspicious behavior data; and
transmitting the suspicious behavior report.

20. A network entity for wireless communication, comprising:
at least one memory; and
at least one processor coupled with the at least one memory and operable to cause the network entity to:
receive a suspicious behavior report comprising suspicious behavior data based on detected suspicious behavior pertaining to a direct communication between a second apparatus and a third apparatus, the suspicious behavior data comprising an event identifier, a timestamp, and one or more of an event identifier, a source identifier for the second apparatus, an application identifier, a service type, service function information, an identifier for the network entity, a destination relay identifier, or traffic telemetry data; and
transmit the suspicious behavior report to a fourth apparatus.

21. A method performed by a network entity, the method comprising:
receiving a suspicious behavior report comprising suspicious behavior data based on detected suspicious behavior pertaining to a direct communication between a second apparatus and a third apparatus, the suspicious behavior data comprising an event identifier, a timestamp, and one or more of an event identifier, a source identifier for the second apparatus, an application identifier, a service type, service function information, an identifier for the network entity, a destination relay identifier, or traffic telemetry data; and
transmitting the suspicious behavior report to a fourth apparatus.

22. The method of claim 19, wherein the suspicious behavior comprises one or more of misbehavior pertaining to the direct communication, malicious behavior pertaining to the direct communication, or suspected malicious behavior pertaining to the direct communication.

23. The method of claim 19, further comprising collecting the traffic telemetry data from the second apparatus, and the traffic telemetry data comprises one or more of suspicious data or a suspicious message.

24. The method of claim 19, wherein the second apparatus comprises one or more of a second UE, a UE-network relay, or a relay node.

25. The method of claim 19, further comprising detecting the suspicious behavior based on at least one of:
the second apparatus causes multiple direct communication link failures;
a message exchange pertaining to the direct communication comprises one or more of traffic or data which deviates from at least one of a standard message exchange protocol or a standard message exchange format;
the second apparatus executes an operation unrecognized by the UE;
the second apparatus transmits data which exceeds a threshold;
a detected error in a direct communication set up procedure which is implemented with the second apparatus; or
a detected error in a direct communication link that is established with the second apparatus.
